(19) United States
(12) Patent Application Publication
(10) Pub. No.: US 2011/0199680 A1
(43) Pub. Date: Aug. 18, 2011

(54) EYEWEAR WITH THREE-DIMENSIONAL VIEWING CAPABILITY

(75) Inventors: Ryan Saylor, Mission Viejo, CA (US); Carlos Reyes, Rancho Santa Margarita, CA (US)

(73) Assignee: Oakley, Inc., Foothill Ranch, CA (US)

(21) Appl. No.: 13/011,764

(22) Filed: Jan. 21, 2011

Related U.S. Application Data
(60) Provisional application No. 61/297,654, filed on Jan. 22, 2010.

(51) Int. Cl. G02B 27/26

(52) U.S. Cl. 359/465

(57) ABSTRACT

Eyewear having three-dimensional (3D) viewing capability is disclosed. The 3D eyewear can include eyeglasses and an eyewear attachment configured to attach to the eyeglasses. The eyeglasses can have lens elements that include linear polarizers, and can be worn by the user without the eyewear attachment during everyday use. The eyewear attachment can include auxiliary lens elements that include quarter-wave plates oriented such that auxiliary lens elements of the eyewear attachment and the lens elements of the eyeglasses cooperate to function as circular polarizers. One lens pair can function as a circular polarizer configured to filter out right-handed circularly polarized light, and the other lens pair can function as a circular polarizer configured to filter out left-handed circularly polarized light. Thus, when the eyeglasses are worn with the eyewear attachment attached thereto, they can function as 3D eyewear to present right-eye and left-eye images, which are displayed using oppositely oriented circularly polarized light, to the respective right or left eye of the wearer. In some embodiments, the auxiliary lens elements can removably attach directly to the lens elements of the eyeglasses.

### CROSS REFERENCE TO RELATED APPLICATIONS

This application claims the benefit under 35 U.S.C. §119(e) of U.S. Provisional Patent Application No. 61/297,654, entitled EYEWEAR WITH THREE-DIMENSIONAL VIEWING CAPABILITY, filed Jan. 22, 2010 (Atty. Docket No. OAKLY1.328PR), the entirety of which is hereby incorporated by reference and made a part of this specification.

### BACKGROUND

1. Field of the Disclosure

This disclosure relates to eyewear having three-dimensional (3D) viewing capability, and more particularly to eyewear attachments for providing 3D viewing capability to eyewear.

2. Description of the Related Art

Various techniques have been developed to present a three-dimensional (3D) image to a viewer using a two-dimensional (2D) format such as a movie screen. Some techniques use specialized eyewear to achieve the 3D effect. For example, right-eye and left-eye images can be superimposed on a screen, and the viewer can wear specialized eyewear having lenses configured to filter the images so that the right-eye image is seen only by the viewer's right eye and the left-eye image is seen only by the viewer's left eye. By superimposing appropriate right-eye and left-eye images, a 3D image can be presented to the viewer wearing the specialized eyewear.

Current 3D eyewear is designed to be worn only when viewing 3D images (e.g., in a movie theater), and not during everyday use or sports activities. Consequently, 3D eyewear is generally made from relatively cheap materials and is often disposable. Frames are often made from paper or thin plastic. Current 3D eyewear is generally available in limited styles and sizes and often causes discomfort when worn for even short periods of time.

Although some advances have been made in 3D eyewear, there remains a need for effective comfortable eyewear that can be used for everyday use as well as for 3D viewing.

### SUMMARY OF THE INVENTION

Eyewear having three-dimensional viewing functionality is disclosed. The eyewear can include a main frame configured to be worn on the face of a wearer, a right lens element supported by the main frame, and a left lens element supported by the main frame. The eyewear can also include an attachment frame having a fastener configured to removably attach the attachment frame to the main frame. A right auxiliary lens element can be supported by the attachment frame and positioned over the right lens element. The right auxiliary lens element and right lens element can cooperate to filter out light polarized in a first direction. A left auxiliary lens element can be supported by the attachment frame and positioned over the left lens element. The left auxiliary lens and the left lens element can cooperate to filter out light polarized in a second direction, wherein the second direction is different than the first direction.

The right lens element can include a first linear polarizer, and the left lens element can include a second linear polarizer. The first linear polarizer can have a transmission axis and the second linear polarizer can have a transmission axis. The transmission axis of the second linear polarizer can be offset from the transmission axis of the first linear polarizer by an angle of deviation of less than about 15°. The angle of deviation between the transmission axis of the second linear polarizer and the transmission axis of the first linear polarizer can be less than about 5°. The transmission axis of the second linear polarizer can be substantially parallel to the transmission axis of the first linear polarizer.

In some embodiments, the right lens element can be integrally formed with the left lens element forming a unitary lens element, and the first linear polarizer can be integrally formed with the second linear polarizer.

The right auxiliary lens element can include a first quarter-wave plate, and the left auxiliary lens element can include a second quarter-wave plate. The first quarter-wave plate and the first linear polarizer can cooperate to create a first circular polarizer configured to filter out light that is circularly polarized in the first direction. The second quarter-wave plate and second linear polarizer can cooperate to create a second circular polarizer configured to filter out light that is circularly polarized in the second direction, with the second direction being substantially opposite the first direction.

The first linear polarizer can be configured to be positioned closer to the wearer's eye than the first quarter-wave plate, and the second linear polarizer can be configured to be positioned closer to the wearer's eye than the second quarter-wave plate.

The first quarter-wave plate can include a fast axis, and the second quarter-wave plate can include a fast axis. The fast axis of the second quarter-wave plate can be offset from the fast axis of the first quarter-wave plate by an angle of deviation between about 75° and about 105°. The angle of deviation between the fast axis of the second quarter-wave plate and the fast axis of the first quarter-wave plate can be between about 85° and about 95°. The angle of deviation between the fast axis of the second quarter-wave plate and the fast axis of the first quarter-wave plate can be about 90°.

A method of adding three-dimensional viewing functionality to eyewear is disclosed. The method includes providing eyewear having a right lens element and a left lens element and attaching an attachment to the eyewear. The attachment can include a right auxiliary lens element and a left auxiliary lens element. The right auxiliary lens element can be positioned over the right lens element and the left auxiliary lens element can be positioned over the left lens element. The right auxiliary lens element and the right lens element can cooperate to filter out light polarized in a first direction. The left auxiliary lens element and the left lens element can cooperate to filter out light polarized in a second direction, with the second direction being different than the first direction.

An eyewear attachment for adding three-dimensional viewing functionality to eyewear is disclosed. The eyewear attachment can include a right auxiliary lens element that includes a first quarter-wave plate and does not include a linear polarizer. The eyewear attachment can include a left auxiliary lens element that includes a second quarter-wave plate and does not include a linear polarizer. The eyewear attachment can further include an attachment frame supporting the right auxiliary lens element and the left auxiliary lens element, and a fastener configured to removably attach the eyewear attachment to the eyewear.

The first quarter-wave plate can include a fast axis, and the second quarter-wave plate can include a fast axis. The fast axis of the second quarter-wave plate can be offset from the fast axis of the first quarter-wave plate by an angle of deviation between about 75° and about 105°. The angle of deviation between the fast axis of the second quarter-wave plate and the fast axis of the first quarter-wave plate can be between about 85° and about 95°. The angle of deviation between the fast axis of the second quarter-wave plate and the fast axis of the first quarter-wave plate can be about 90°.

The fastener can include one or more connectors, such as snaps, hooks or clips. The fastener can be configured to removably attach the eyewear attachment to a main frame of the eyewear.

In some embodiments, the eyewear attachment can be used with eyewear configured to removably receive the fastener. The eyewear can include a main frame configured to be worn on the face of a wearer. A right lens element can be supported by the main frame, and the right lens element can include a first linear polarizer. A left lens element can be supported by the main frame, and the left lens element can include a second linear polarizer. The first quarter-wave plate and the first linear polarizer can cooperate to create a first circular polarizer configured to filter out light that is circularly polarized in the first direction. The second quarter-wave plate and second linear polarizer can cooperate to create a second circular polarizer configured to filter out light that is circularly polarized in the second direction, the second direction being substantially opposite the first direction.

The first linear polarizer can have a transmission axis and the second linear polarizer can have a transmission axis. The transmission axis of the second linear polarizer can be offset from the transmission axis of the first linear polarizer by an angle of deviation of less than about 15°. The angle of deviation between the transmission axis of the second linear polarizer and the transmission axis of the first linear polarizer can be less than about 5°. The transmission axis of the second linear polarizer can be substantially parallel to the transmission axis of the first linear polarizer.

Eyewear having three-dimensional viewing functionality is disclosed. The eyewear can include a frame configured to be worn on the face of a wearer; a right lens element supported by the frame, the right lens element having a front surface and a back surface; and a left lens element supported by the frame, the left lens element having a front surface and a back surface. The eyewear can also include a right auxiliary lens element configured to removably attached to the front surface of the right lens element to thereby substantially block light polarized in a first direction from passing through the right lens element. The eyewear can also include a left auxiliary lens element configured to removably attach to the front surface of the left auxiliary lens element to thereby substantially block light polarized in a second direction from passing through the left lens element, wherein the second direction is different than the first direction. Attachment can be accomplished by mechanical interfit between a peripheral aspect of the auxiliary lens and the adjacent orbital on the frame. Alternatively, the auxiliary lens may be adhered directly to the front surface of the underlying lens by static attraction, optically transmissive adhesives, or by applying a liquid between the two adjacent surfaces such as a drop or small volume of water or index matching medium.

The right auxiliary lens element can include a first quarter-wave plate, and the left auxiliary lens element can include a second quarter-wave plate. The right lens element can include a first linear polarizer, and the left lens element can include a second linear polarizer. The first quarter-wave plate and first linear polarizer can cooperate to form a first circular polarizer configured to substantially block light that is circularly polarized in the first direction. The second quarter-wave plate and the second linear polarizer can cooperate to form a second circular polarizer configured to substantially block light that is circularly polarized in a second direction, the second direction being substantially opposite the first direction.

The right auxiliary lens element can include a first linear polarizer, and the left auxiliary lens element can include a second linear polarizer. The first quarter-wave plate and first linear polarizer can cooperate to form a first circular polarizer configured to substantially block light that is circularly polarized in the first direction. The second quarter-wave plate and the second linear polarizer can cooperate to form a second circular polarizer configured to substantially block light that is circularly polarized in a second direction, the second direction being substantially opposite the first direction.

The right lens element and the right auxiliary lens element can be shaped so that the right auxiliary lens element can only be attached to the right lens element in a desired orientation, and the left lens element and the left auxiliary lens element can be shaped so that the left auxiliary lens element can only be attached to the left lens element in a desired orientation.

The right auxiliary lens element can include a marking configured to indicate a desired orientation of the right auxiliary lens element, and the left auxiliary lens element can include a marking configured to indicate a desired orientation of the left auxiliary lens element. The frame can include a right frame marking configured to align with the marking on the right auxiliary lens element when the right auxiliary lens element is oriented in the desired orientation, and the frame can include a left frame marking configured to align with the marking on the left auxiliary lens element when the left auxiliary lens element is oriented in the desired orientation.

The right and left auxiliary lens elements can be flexible. The right auxiliary lens element can have a curvature that is substantially the same as the curvature of the front surface of the right lens element, and the left auxiliary lens element can have a curvature that is substantially the same as the curvature of the front surface of the left lens element. The curvatures of the front surfaces of the right and left lens elements can be substantially spherical in shape, and the curvatures of the right and left auxiliary lens elements can be substantially spherical in shape.

At least one of the right and left lens elements can be a prescription lens element. The right lens element can be integrally formed with the left lens element forming a unitary lens element. The right auxiliary lens element can be integrally formed with the left auxiliary lens element forming a unitary auxiliary lens element.

A method of adding three-dimensional viewing functionality to eyewear is disclosed. The method can include providing eyewear having a right lens element and a left lens element, the right lens element having a front surface and a back surface, and the left lens element having a front surface and a back surface; attaching a right auxiliary lens element to the front surface of the right lens element to thereby substantially block light polarized in a first direction from passing through the right lens element; and attaching a left auxiliary lens element to the front surface of the left lens element to thereby substantially block light polarized in a first direction from passing through the right lens element, wherein the first direction is different than the second direction.

An auxiliary lens element for adding three-dimensional viewing functionality to eyewear is disclosed. The auxiliary lens element can include a front surface, a back surface configured to removably attach to a front surface of a lens element of the eyewear, and a quarter-wave plate having a fast axis. The auxiliary lens element can further include a linear polarizer having a transmission axis, and the fast axis of the quarter-wave plate can be offset from the transmission axis of the linear polarizer by an angle of deviation of between about 40° and 50°. The angle of deviation between the fast axis of the quarter-wave and the transmission axis of the linear polarizer can be about 45°.

The auxiliary lens element can further include eyewear configured to receive the auxiliary lens element. The eyewear can include a frame configured to be worn on the face of a wearer, and at least one lens element supported by the frame. The lens element can have a front surface and a back surface, and the front surface of the lens element can be configured to receive the back surface of the auxiliary lens element to removably secure the auxiliary lens element to the lens element. The lens element can include a linear polarizer.

The auxiliary lens element can further include a right marking indicating the proper orientation of the auxiliary lens element on a right lens element, and a left marking indicating the proper orientation of the auxiliary lens element on a left lens element.

### BRIEF DESCRIPTION OF THE DRAWINGS

FIG. 1 schematically shows a 3D viewing system that incorporates eyewear having 3D viewing capability.

FIG. 2 schematically shows a rear view of a pair of eyeglasses (e.g., sunglasses).

FIG. 3 schematically shows a rear view of an eyewear attachment configured to add 3D viewing capability to the eyeglasses of FIG. 2.

FIG. 4 is a perspective view that schematically shows right-handed circularly polarized light impinging on the eyewear attachment of FIG. 3 and the eyeglasses of FIG. 2.

FIG. 5 is a perspective view that schematically shows left-handed circularly polarized light impinging on the eyewear attachment of FIG. 3 and the eyeglasses of FIG. 2.

FIG. 6 schematically illustrates a cross-sectional view of an example embodiment of a lens for use in the eyeglasses of FIG. 2.

FIG. 7 schematically illustrates a cross-sectional view of an example embodiment of a lens for use in the eyewear attachment of FIG. 3.

FIG. 8 schematically illustrates another embodiment of eyewear having 3D viewing capabilities.

FIG. 8A schematically illustrates the eyeglasses of FIG. 8 having auxiliary lens elements removably attached to the lens elements thereof.

FIG. 9 schematically illustrates an auxiliary lens element that can be removably attached to either a right or a left lens element.

FIG. 10 schematically illustrates a cross-sectional view of an example embodiment of a lens for use as an auxiliary lens element to be attached to a lens element.

### DETAILED DESCRIPTION OF THE PREFERRED EMBODIMENT

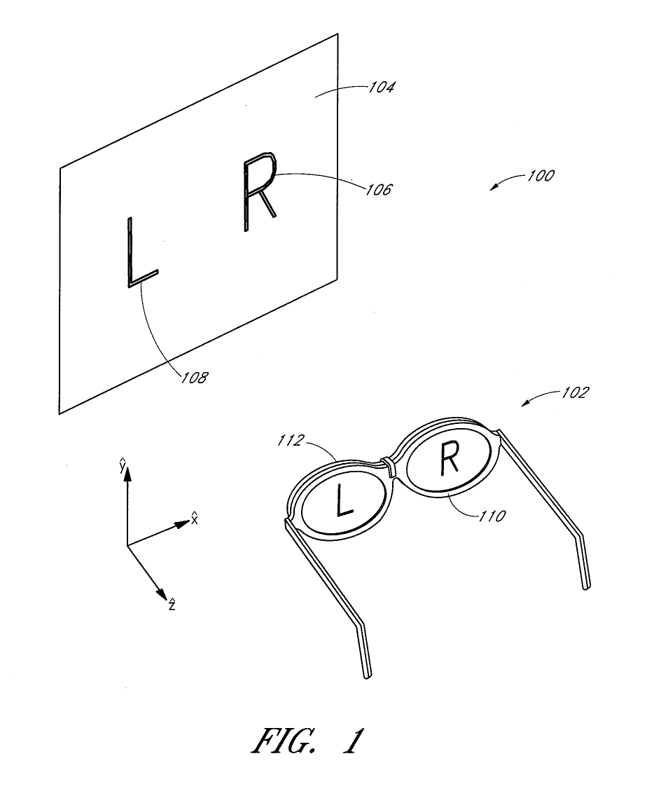

FIG. 1 schematically shows a 3D viewing system 100 that incorporates eyewear 102 having 3D viewing capability. The system 100 includes a display screen 104 for displaying right-eye images 106 and left-eye images 108. The 3D eyewear 102 can include a pair of eyeglasses 110 which the wearer can wear during everyday use or during sports activities. Eyeglasses 110 may include water white prescription lenses, water white plano lenses or may be provided with a light transmission modifier. Transmission modifiers can include conventional sunglass technologies such as light absorbing dyes, photochromic films or additives, or contrast enhancing systems such as trichroic systems for selectively suppressing preselected wavelengths of light, as is discussed further below.

The 3D eyewear 102 can also include an attachment 112 configured to attach to the eyeglasses 110. When the attachment 112 is attached to the eyeglasses 110, the lenses of the attachment 112 and the lenses of the eyeglasses 110 cooperate to filter the right-eye and left-eye images 106, 108 so that the right-eye images 106 are presented only to the wearer's right eye and the left-eye images are presented only to the wearer's left eye. In some embodiments, when the attachment 112 is detached, the eyeglasses 110 do not provide 3D viewing capabilities, and the eyeglasses 110 can be worn during everyday use or during sports activities. In some embodiments, the attachment 112 is also incapable of providing 3D viewing capabilities without the eyeglasses 110. Thus, the lenses of the eyeglasses 110 and the lenses of the attachment 112 can cooperate to provide the 3D viewing capabilities.

For convenience, a three-dimensional coordinate system having the x-, y-, and z-axes is shown in FIG. 1, as well as in various other Figures herein. The coordinate system can be defined as having the x-axis aligned to cross through the centers of the lenses, and the z-axis pointing from the display screen 104 toward the viewer along the line of sight. It should be understood that the coordinate system described is for illustrative purposes only and other coordinate systems and other configurations can be used.

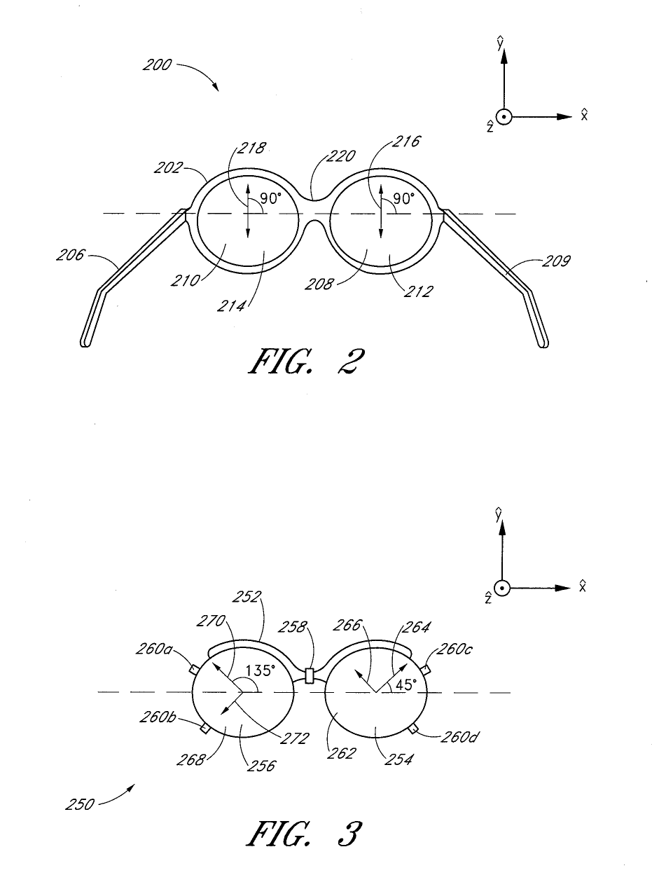

FIG. 2 schematically shows a rear view of a pair of eyeglasses 200 (e.g., sunglasses), which can be similar to, or the same as, the eyeglasses 110 discussed above. The eyeglasses 200 can include a main frame 202, a right earstem 204, and a left earstem 206. The main frame 202 and earstems 204, 206 can be configured to be worn on the face of a wearer. The main frame 202 can include partial or full right and left orbitals for supporting a right lens element 208 and a left lens element 210. In some embodiments, the right lens element 208 can include a first linear polarizer 212, and the left lens element can include a second linear polarizer 214. The linear polarizers 212, 214 can be oriented such that the transmission axis 216 of the first linear polarizer 212 is substantially parallel to the transmission axis 218 of the second linear polarizer 214. In some embodiments, the transmission axis 216 of the first linear polarizer 212 deviates from the transmission axis 218 of the second linear polarizer 214 by no more than about 15° or by no more than about 5°.

In the embodiment shown in FIG. 2, the linear polarizers 212, 214 are oriented such that both transmission axes 216, 218 are oriented substantially vertically (i.e., substantially along the y-axis). When the eyeglasses 200 are worn level on the face of the wearer, the linear polarizers 212, 214 can be configured to substantially block horizontally polarized light from passing through the lens elements 208, 210 while allowing vertically polarized light to pass through the lens elements 208, 210 substantially unattenuated. Thus, the eyeglasses 200 can function to block horizontally polarized glare (e.g., reflected from water or other horizontal surfaces) from reaching the eyes of the wearer, which can be advantageous when engaging in various activities (e.g., driving, fishing, or sports activities). It will be understood that the linear polarizers 212, 214 can be oriented in various other manners, such as to block vertically polarized light. In some embodiments, the linear polarizers 212, 214 can be oriented at some angle between the x-axis and y-axis.

Because the linear polarizers 212, 214 also block about half of unpolarized light, the lens elements 208, 210 can also reduce the intensity of light that reaches the wearer's eyes. The lens elements 208, 210 can include additional light attenuating features to further reduce the intensity of light that reaches the wearer's eyes. The additional light attenuating features can include, for example, coatings (e.g., mirrored coatings), dyes, or other elements that reflect or absorb light. In some embodiments, the lens elements 208, 210 can include photochromic compositions that darken in bright light and fade in lower light environments. Such compositions can include, for example, but without limitation, silver, copper, and cadmium halides. Photochromic compounds for lenses are disclosed in U.S. Pat. Nos. 6,312,811, 5,658,502, 4,537,612, each of which is hereby expressly incorporated by reference in its entirety. Photochromic lenses can provide relatively little light attenuation when viewing three-dimensional images in a lower light environment, such as in a movie theater, but can automatically provide increased light attenuation when used in bright light, such as when worn outdoors.

It will be understood that the eyeglasses 200 shown in FIG. 2 can be modified in various manners. For example, the main frame 202 can include continuous orbitals that fully encircle the lens elements 208, 210 (as shown in FIG. 2). Alternatively, the orbitals may bound only the top edges, or bottom edges, or any other portions of the lens elements 208, 210. In some embodiments, the main frame 202 can be merely a bridge piece connecting upper inside portions of the lens elements 208, 210. Various other frame designs are possible. The earstems 204, 206 may attach, for example, to the main frame 202 or directly to the lens elements 208, 210, via either a hinge or fixed connection. The main frame 202 and earstems 204, 206 may comprise any of a variety of metals, composites, or relatively rigid, molded thermoplastic materials which are well known in the art, and may be transparent or any of a variety of colors.

In some embodiments, the right lens element 208 and left lens element 210 can be integrally formed as a single unitary lens element. Likewise, the first linear polarizer 212 and second linear polarizer 214 can be integrally formed as a single unitary linear polarizer. In embodiments having a unitary lens, the right lens element 208 refers to the portion of the unitary lens element associated with the wearer's right eye, and the left lens element 210 refers to the portion of the unitary lens element associated with the wearer's left eye. Likewise, the first linear polarizer 212 refers to the portion of the unitary linear polarizer associated with the wearer's right eye, and the second linear polarizer 214 refers to the portion of the unitary linear polarizer associated with the wearer's left eye.

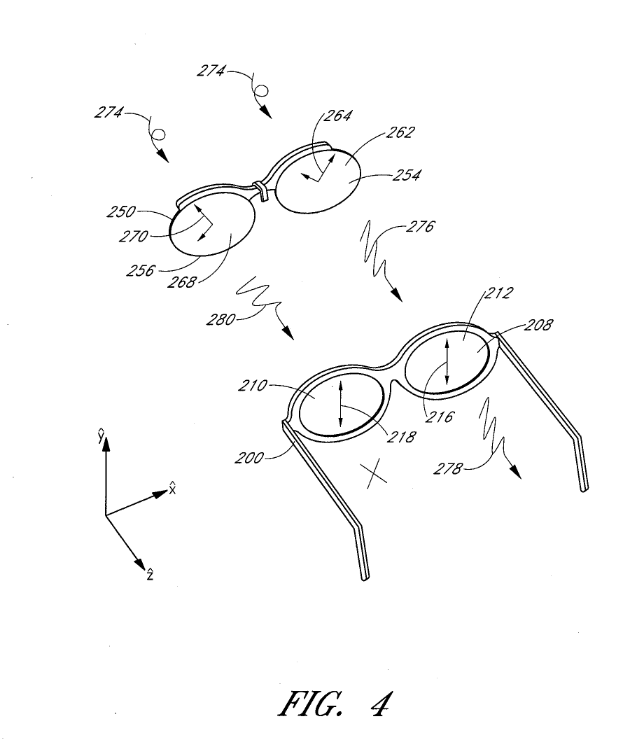

Turning now to FIG. 3, a rear view of an eyewear attachment 250 is shown schematically. The eyewear attachment 250 can be similar to, or the same as, the attachment 112 discussed above. The eyewear attachment 250 can include an attachment frame 252. The attachment frame 252 can support a right auxiliary lens element 254 and a left auxiliary lens element 256. The attachment frame 252 can include a fastener configured to removably attach the eyewear attachment 250 to the eyeglasses 200 such that the right auxiliary lens element 254 is positioned over the right lens element 208, and the left auxiliary lens element 256 is positioned over the left lens element 210. The fastener can include one or more clips, snap-fit mechanisms, or other releasable fastening structures.

The lens elements 254 and 256 may have zero power, or may be configured with decentered front and rear surfaces to provide an effect like correction of prismatic shift or other optical objective.

In the embodiment shown in FIG. 3, the eyewear attachment 250 includes a clip 258 on the bridge of the attachment frame 252. The clip 258 is configured to removably receive a complementary surface structure on the bridge portion of the main frame 202 of the eyeglasses 200. Alternatively, the eyewear attachment 250 can include multiple (e.g., 2 or 3 or 4 or more) connectors such as clips or tabs 260a-d which can be configured to removably engage corresponding structure on the main frame 202 or of the lens elements 208, 210 such that the eyewear attachment 250 “snaps” onto the eyeglasses 200. It will be understood that many alternative designs are possible. Complementary pairs of magnets may alternatively be used.

In some embodiments, the eyewear attachment 250 can be specially designed for use with a particular style, shape, or size of eyeglasses 200. For example, the eyewear attachment 250 can have a curved horizontal contour (e.g., wrap) that is compatible with the curved contour (e.g., wrap) of the eyeglasses 200. The auxiliary lens elements 254, 256 can be shaped so as to substantially cover the respective right and left lens elements 208, 210 without extending substantially past the edges of the respective right and left lens elements 208, 210. Alternatively, the auxiliary lens elements 254, 256 can be shaped so as to cover only a portion of the respective right and left lens elements 208, 210, or to cover an area in excess of the respective right and left lens elements 208, 210.

When attached, the auxiliary lens elements 254, 256 can be positioned such that the back surfaces of the auxiliary lens elements 254, 256 are positioned at most about 5 mm and/or at least about 1 mm from the front surfaces of the respective right and left lens elements 208, 210, although values outside this range may also be used. In some embodiments, the back surfaces of the auxiliary lens elements 254, 256 are positioned so as to touch the front surfaces of the respective right and left lens elements 208, 210. In some embodiments, the eyewear attachment 250 can include pads (not shown in FIG. 3) or other features which act as a spatial buffer between the eyewear attachment 250 and the eyeglasses 200 so that the auxiliary lens elements 254, 256 are maintained close to (e.g., within about 5 mm, 3 mm, 1 mm, 0.5 mm, or less), but not touching, the respective right and left lens elements 208, 210.

In some embodiments, the eyeglasses 200 can be specially designed to removably receive the fastener on attachment frame 252. For example, the bridge portion of the main frame 202 can include an attachment region 220 configured (e.g., shaped or sized) to receive the fastener (e.g., clip 258) such that the eyewear attachment 250 is properly oriented on the eyeglasses 200. The attachment region 220 can be, for example, a narrowed portion or otherwise complementary surface structure of the bridge that prevents the clip 258 from being attached to the bridge at a location too far to either side.

It will be understood that the eyewear attachment 250 shown in FIG. 3 can be modified in various manners. For example, the attachment frame 252 can include orbitals that bound only the top portions of the auxiliary lens elements 254, 256 (as shown in FIG. 3). Alternatively, the obritals may fully encircle the auxiliary lens elements 254, 256, or may bound any other portions of the auxiliary lens elements 254, 256. In some embodiments, the attachment frame 252 can be merely a bridge piece connecting upper inside portions of the auxiliary lens elements 254, 256. Various other frame designs are possible. The attachment frame 252 may comprise any of a variety of metals, composites, or relatively rigid, molded thermoplastic materials which are well known in the art, and may be transparent or any of a variety of colors.

In some embodiments, the right auxiliary lens element 254 and left auxiliary lens element 256 can be integrally formed as a single unitary auxiliary lens element. In embodiments having a unitary auxiliary lens, the right auxiliary lens element 254 refers to the portion of the unitary auxiliary lens element associated with the wearer's right eye, and the left auxiliary lens element 256 refers to the portion of the unitary auxiliary lens element associated with the wearer's left eye.

The right auxiliary lens element 254 can include a first quarter-wave plate 262 having a fast axis 264 and a slow axis 266. Likewise, the left auxiliary lens element 256 can include a second quarter-wave plate 268 having a fast axis 270 and a slow axis 272. As used herein the term quarter-wave plate is used broadly to encompass quarter-wave plates, quarter-wave retarders, and other suitable optical elements capable of creating a quarter-wavelength phase shift between substantially perpendicular polarization components of a light wave traveling therethrough. In some embodiments, the fast axis 264 of the first quarter-wave plate 262 can be offset from the fast axis 270 of the second quarter-wave plate 268 by an angle of deviation of between about 75° and about 105°, between about 85° and about 95°, or about 90°. For example, in the embodiment shown in FIG. 3, the fast axis 264 of the first quarter-wave plate 262 is offset from the x-axis by about 45°, and the fast axis 270 of the second quarter-wave plate 268 is offset from the x-axis by about 135°. It will be understood that various other orientations are also possible.

When the eyewear attachment 150 is attached to the eyeglasses 200, the fast axis 264 of the first quarter-wave plate 262 can be offset from the transmission axis 216 of the first linear polarizer 212 by about 45° in a first direction, and the fast axis 270 of the second quarter-wave plate 268 can be offset from the transmission axis 218 of the second linear polarizer 214 by about 45° in a second direction opposite the first direction. It should be noted that in some embodiments, the auxiliary lens elements 254, 256 do not include linear polarizers.

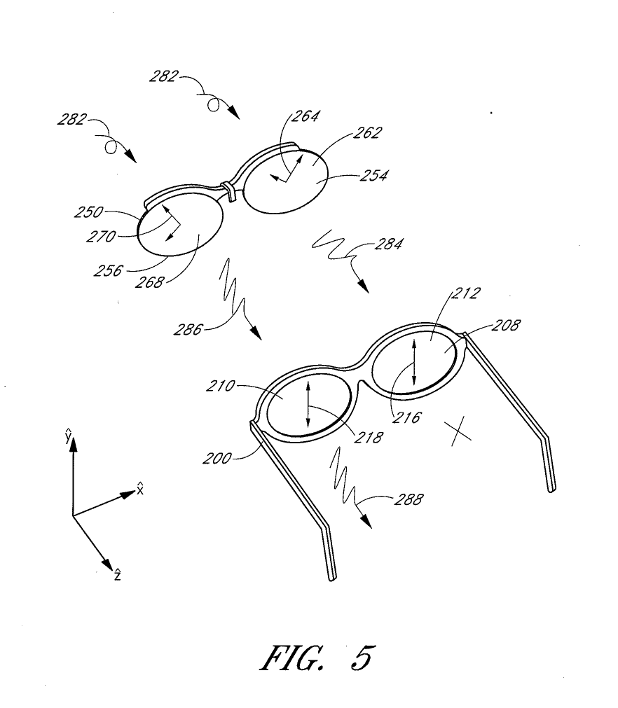

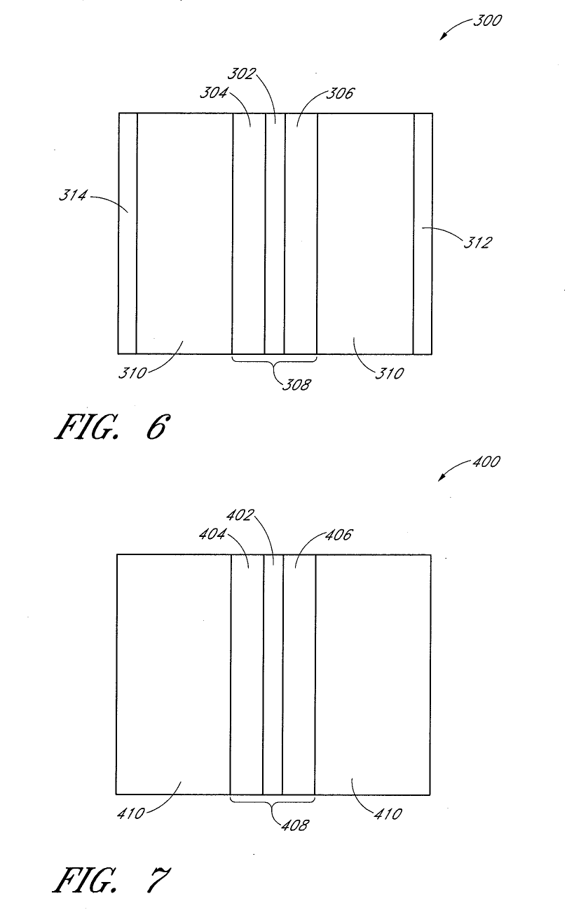

When the eyewear attachment 150 is attached to the eyeglasses 200, the first quarter-wave plate 262 and first linear polarizer 212 can cooperate to function as a first circular polarizer configured to filter out circularly polarized light of a first direction (e.g., left-handed circularly polarized light) and configured to allow circularly polarized light of a second direction (e.g., right-handed circularly polarized light) to pass through substantially unattenuated. The second quarter-wave plate 268 and second linear polarizer 214 can cooperate to function as a second circular polarizer configured to filter out circularly polarized light of the second direction (e.g., right-handed circularly polarized light) and configured to allow circularly polarized light of the first direction (e.g., left-handed circularly polarized light) to pass through substantially unattenuated. Thus, the first circular polarizer can function to filter out light polarized in the opposite direction as the light filtered out by the second circular polarizer. The optical functionality of the eyeglasses 200 and eyewear attachment 250 will be discussed further below in connection with FIGS. 4 and 5.

FIG. 4 is a perspective view that schematically shows right-handed circularly polarized light 274 impinging on the eyewear attachment 250 and eyeglasses 200. The eyewear attachment 250 and eyeglasses 200 are shown in FIG. 4 as being separated along the line of sight by a significant distance solely for demonstrative purposes. When in use, the eyewear attachment 250 can be attached to the eyeglasses 200 as discussed above. When in use, the linear polarizers 212, 214 can be positioned closer to the wearer's eyes than the quarter-wave plates 262, 268.

Right-handed circularly polarized light 274 can be used to display right-eye images (e.g., 106 of FIG. 1). Right-handed circularly polarized light 274 can be represented by Jones vector (1) shown below.

$$\frac{1}{\sqrt{2}} [ \begin{matrix}1 \\ - i\end{matrix} ] \qquad ( 1 )$$

The right-handed circularly polarized light 274 propagates to the viewer and first impinges on the right and left auxiliary lens elements 254, 256 of the eyewear attachment 250. The light that passes through the right and left auxiliary lens elements 254, 256 then impinges on the right and left lens elements 208, 210 of the eyeglasses.

The right auxiliary lens element 254 can contain the first quarter-wave plate 262 having its fast axis 264 offset by 45° from the x-axis, represented by Jones matrix (2) shown below.

$$\frac{1}{\sqrt{2}} [ \begin{matrix}1 & - i \\ - i & 1\end{matrix} ] \qquad ( 2 )$$

The first quarter-wave plate 262 converts the right-handed circularly polarized light 274 into vertically linearly polarized light 276, as shown by the equation (3) shown below.

$$\frac{1}{\sqrt{2}} [ \begin{matrix}1 & - i \\ - i & 1\end{matrix} ] \frac{1}{\sqrt{2}} [ \begin{matrix}1 \\ - i\end{matrix} ] = - i [ \begin{matrix}0 \\ 1\end{matrix} ] \qquad ( 3 )$$

The −i on the right side of the equation can be ignored because it merely represents a phase change.

The vertically polarized light 276 propagates to the first linear polarizer 212 which has its transmission axis 216 aligned vertically. The first linear polarizer 212 can be represented by Jones matrix (4) shown below.

$$[ \begin{matrix}0 & 0 \\ 0 & 1\end{matrix} ] \qquad ( 4 )$$

The vertically polarized light 276 passes through the first linear polarizer 212 substantially unaffected, as shown by equation 5 shown below.

$$[ \begin{matrix}0 & 0 \\ 0 & 1\end{matrix} ] [ \begin{matrix}0 \\ 1\end{matrix} ] = [ \begin{matrix}0 \\ 1\end{matrix} ] \qquad ( 5 )$$

The vertically linearly polarized light 278 then propagates to the viewer's right eye. Thus, the right-eye image (e.g., 106 of FIG. 1) is viewable by the viewer's right eye.

The left auxiliary lens element 256 can contain the second quarter-wave plate 268 having its fast axis 270 offset by 135° from the x-axis, represented by Jones matrix (6) shown below.

$$\frac{1}{\sqrt{2}} [ \begin{matrix}1 & i \\ i & 1\end{matrix} ] \qquad ( 6 )$$

The second quarter-wave plate 268 converts the right-handed circularly polarized light 274 into horizontally linearly polarized light 280, as shown by equation (7) shown below.

$$\frac{1}{\sqrt{2}} [ \begin{matrix}1 & i \\ i & 1\end{matrix} ] \frac{1}{\sqrt{2}} [ \begin{matrix}1 \\ - i\end{matrix} ] = [ \begin{matrix}1 \\ 0\end{matrix} ] \qquad ( 7 )$$

The horizontally polarized light 280 propagates to the second linear polarizer 214 which has its transmission axis 218 aligned vertically. The second linear polarizer 214 can be represented by the Jones matrix (4) shown above. The horizontally polarized light 280 is blocked by the second linear polarizer 214 as shown by equation (8) shown below.

$$[ \begin{matrix}0 & 0 \\ 0 & 1\end{matrix} ] [ \begin{matrix}1 \\ 0\end{matrix} ] = [ \begin{matrix}0 \\ 0\end{matrix} ] \qquad ( 8 )$$

Thus, the right-eye image is not viewable by the viewer's left eye.

FIG. 5 is a perspective view that schematically shows left-handed circularly polarized light 282 impinging on the eyewear attachment 250 and eyeglasses 200. The eyewear attachment 250 and eyeglasses 200 are shown in FIG. 5 as being separated by a significant distance solely for demonstrative purposes. When in use, the eyewear attachment 250 can be attached to the eyeglasses 200 as discussed above.

Left-handed circularly polarized light 282 can be used to display left-eye images (e.g., 108 of FIG. 1). Left-handed circularly polarized light 282 can be represented by Jones vector (9) shown below.

$$\frac{1}{\sqrt{2}} [ \begin{matrix}1 \\ i\end{matrix} ] \qquad ( 9 )$$

The left-handed circularly polarized light 282 propagates to the viewer and first impinges on the right and left auxiliary lens elements 254, 256 of the eyewear attachment 250. The light that passes through the right and left auxiliary lens elements 254, 256 then impinges on the right and left lens elements 208, 210 of the eyeglasses.

The right auxiliary lens element 254 can contain the first quarter-wave plate 262 having its fast axis 264 offset by 45° from the x-axis, represented by Jones matrix (2) shown above. The first quarter-wave plate 262 converts the left-handed circularly polarized light 282 into horizontally linearly polarized light 284 as shown by equation (10) shown below.

$$\frac{1}{\sqrt{2}} [ \begin{matrix}1 & - i \\ - i & 1\end{matrix} ] \frac{1}{\sqrt{2}} [ \begin{matrix}1 \\ i\end{matrix} ] = [ \begin{matrix}1 \\ 0\end{matrix} ] \qquad ( 10 )$$

The horizontally polarized light 284 propagates to the first linear polarizer 212 which has its transmission axis 216 aligned vertically. The first linear polarizer 212 can be represented by Jones matrix (4) shown above. The horizontally polarized light 284 is blocked by the first linear polarizer 212 as shown by equation (11) shown below.

$$[ \begin{matrix}0 & 0 \\ 0 & 1\end{matrix} ] [ \begin{matrix}1 \\ 0\end{matrix} ] = [ \begin{matrix}0 \\ 0\end{matrix} ] \qquad ( 11 )$$

Thus, the left-eye image (e.g., 108 of FIG. 1) is not viewable by the viewer's right eye.

The left auxiliary lens element 256 can contain the second quarter-wave plate 268 having its fast axis 270 offset by 135° from the x-axis, represented by Jones matrix (6) shown above. The second quarter-wave plate 268 converts the left-handed circularly polarized light 282 into vertically linearly polarized light 286 as shown by equation (12) shown below.

$$\frac{1}{\sqrt{2}} [ \begin{matrix}1 & i \\ i & 1\end{matrix} ] \frac{1}{\sqrt{2}} [ \begin{matrix}1 \\ i\end{matrix} ] = i [ \begin{matrix}0 \\ 1\end{matrix} ] \qquad ( 12 )$$

The i on the right side of the equation can be ignored because it merely represents a phase change.

The vertically polarized light 286 propagates to the second linear polarizer 214 which has its transmission axis 218 aligned vertically. The second linear polarizer 214 can be represented by Jones matrix (4) shown above. The vertically polarized light 286 passes through the first linear polarizer 212 substantially unaffected as shown by equation (13) shown below.

$$[ \begin{matrix}0 & 0 \\ 0 & 1\end{matrix} ] [ \begin{matrix}0 \\ 1\end{matrix} ] = [ \begin{matrix}0 \\ 1\end{matrix} ] \qquad ( 13 )$$

The vertically linearly polarized light 288 then propagates to the viewer's left eye. Thus, the left-eye image (e.g., 108 of FIG. 1) is viewable by the viewer's left eye.

It will be understood that many other configurations are possible. For example, if right-eye images are displayed using left-handed circularly polarized light and left-eye images are displayed using right-handed circularly polarized light, the auxiliary lens elements 254, 256 can be adjusted such that the right-eye images are viewable only by the wearer's right eye and such that the left-eye images are viewable only by the wearer's left eye. Also, if the linear polarizers 212, 214 are oriented such that their transmission axes 216, 218 are offset from the y-axis by some angle, the orientations of the quarter-wave plates 262, 268 can be adjusted accordingly.

Although FIGS. 4 and 5 are discussed in the context of the eyeglasses 200 and eyewear attachment 250 being maintained at a level position, it will be understood that the eyeglasses 200 and eyewear attachment 250 will continue to function to filter the right- and left-eye images when the wearer tilts his head. This is because the circular polarizers that result from the combination of the auxiliary lens elements 254, 256 and corresponding lens elements 208, 210 can be rotated without affecting the viewed image. For example, a right-handed circular polarizing filter remains right-handed oriented when it is rotated.

As used herein, the term circular polarizer is intended to include polarizers that produce partially elliptically polarized light as well as polarizers that produce completely circularly polarized light. Similarly, the term circularly polarized light is intended to include light that is partially elliptically polarized as well as light that is completely circularly polarized.

In some embodiments, the eyeglasses 200 can be a standard pair of polarized sunglasses which the user may wear during everyday use or during sports activities. Because a wide variety of shapes, sizes, and styles of sunglasses are available, a user can select a pair of sunglasses which fit comfortably and are compatible with the user's style preferences. Through use of the eyewear attachment 250, the standard polarized sunglasses can be converted into 3D eyewear for use in connection with a 3D viewing experience (e.g., a 3D movie).

Traditionally, 3D eyewear has been made from low-quality materials such as paper and cheap plastic, often as disposable units. Although some non-disposable 3D eyeglasses exist, they are available in very limited styles and sizes. By using the eyeglasses 200 and eyewear attachment 250, the user is able to wear high-quality 3D eyewear of a style, shape, and size of the user's own selection, resulting in a more pleasing 3D viewing experience. Because the eyeglasses 200 can be used for both 3D viewing and normal everyday use, the user may purchase fewer pairs of eyeglasses and carry fewer pairs of eyeglasses. Additionally, waste can be reduced because the user need not use traditional disposable 3D eyewear for 3D viewing.

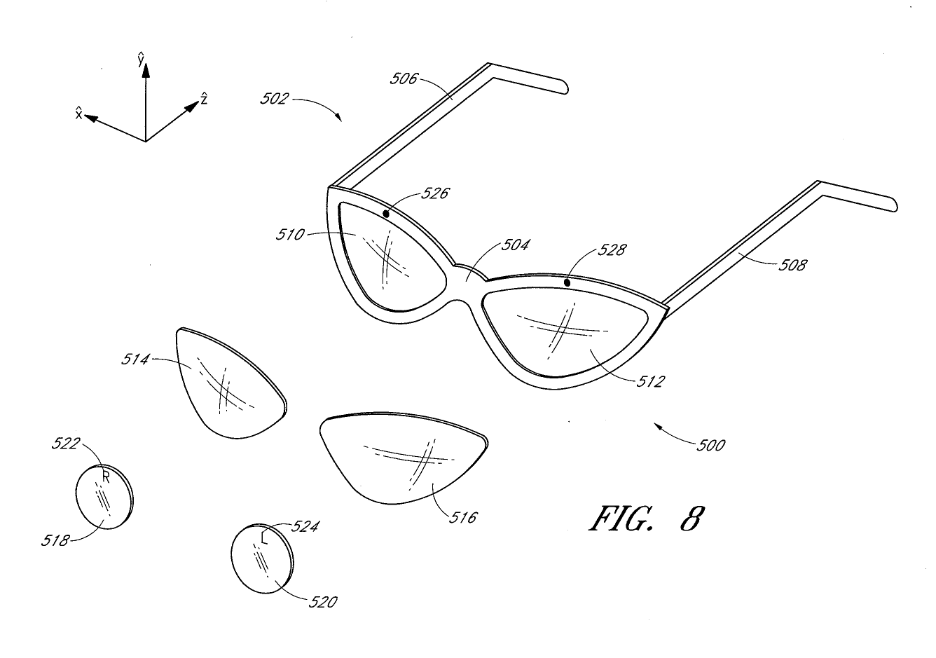

FIG. 6 schematically illustrates a cross-sectional view of an example embodiment of a lens 300 for use in eyeglasses (e.g., eyeglasses 200 discussed above). The lens can be the same as, or similar to, the right lens element 208 or left lens element 210 discussed above. In some embodiments, the lens 300 can be a multilayered lens. The lens 300 can include a linear polarizer layer 302, encased between two layers of stretched polycarbonate sheets 304, 306, forming a polarizer wafer 308. The polarizer wafer 308 can be placed into a mold and additional polycarbonate, CR-39 or other lens material can be injected into the mold to form the lens body 310. An optional antireflective coating 312 can be applied on the back surface (closest to the wearer's eye) of the lens 300. An optional hard coat layer 314 can be applied to the front surface (furthest from the wearer's eye) of the lens 300. In some embodiments, adhesive layers (not shown in FIG. 6) can be positioned between some of the layers to hold the layers together. In some embodiments, some of the layers discussed above can be omitted or can be rearranged. For example, the lens 300 can include a hard coat layer on its back surface, front surface, both surfaces, or neither surface.

In some embodiments the lens 300 can include additional optically functional layers. The additional optically functional layers can include a photochromic layer, or other layers for modifying the optical components of eyewear lenses that are known in the art or yet to be devised. In some embodiments, the lens 300 can include intermediary layers (e.g., made of polycarbonate) to separate optically functional layers to provide, for example, thermal isolation between layers.

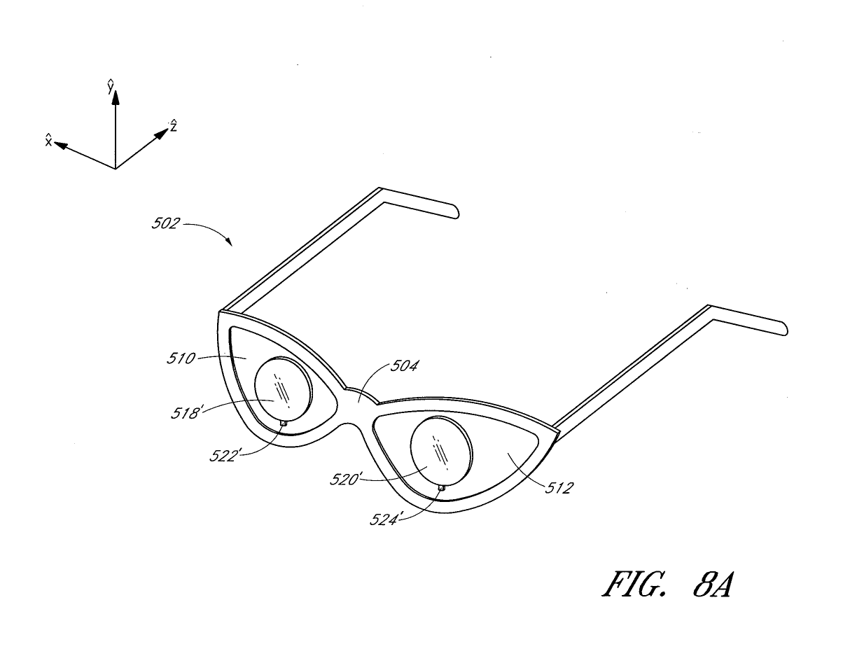

FIG. 7 schematically illustrates a cross-sectional view of an example embodiment of a lens 400 for use in an eyewear attachment (e.g., attachment 250 discussed above). The lens can be the same as, or similar to, the right auxiliary lens element 254 or left auxiliary lens element 256 discussed above. In some embodiments, the lens 400 can be a multilayered lens. The lens 400 can include a quarter-wave plate 402, encased between two layers of stretched polycarbonate sheets 404, 406, forming a quarter-wave plate wafer 408. The quarter-wave plate wafer 308 can be placed into a mold and additional polycarbonate material can be injected into the mold to form the polycarbonate lens body 410. Additional, optional layers can be added, such as antireflective coatings, hard coat layers, or other optically functional layers as are known in the art or yet to be devised. A variety of other materials can be used in place of polycarbonate, such as CR-39. In some embodiments, adhesive layers (not shown in FIG. 7) can be positioned between some of the layers to hold the layers together.

In some embodiments, some of the layers discussed above can be omitted or can be rearranged. For example it may be desirable to minimize the weight and thickness of the clip on lens 400. This may be accomplished by mounting a quarter wave plate wafer 408 directly to the releasable attachment structures or to a secondary frame 252. Typically, however, the wafer 408 will be molded, laminated or otherwise bonded to at least one support layer such as polycarbonate lens body 410. In one embodiment, the lens body imparts substantially zero power, and has a maximum thickness of no greater than about 2.5 mm, and often no greater than about 1.0 mm.

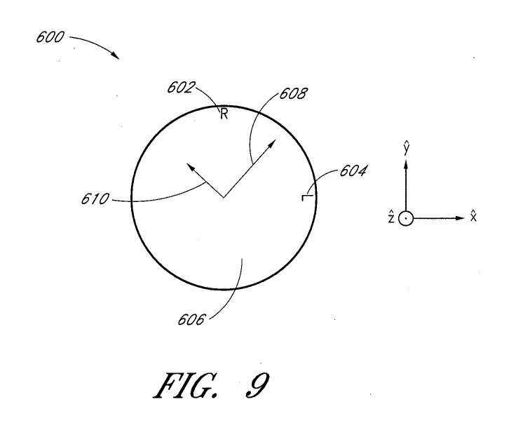

FIG. 8 schematically illustrates another embodiment of eyewear 500 having 3D viewing capabilities. The eyewear 500 can include a pair of eyeglasses 502 which can be similar to, or the same as, the eyeglasses 200 discussed above. The eyeglasses 502 can include a frame 504, a right earstem 506, a left earstem 508, a right lens element 510, and a left lens element 512. In some embodiments, the lens elements 510, 512 can be similar to the lens elements 208, 210 discussed above, and can be, for example, structurally similar to the lens 300 discussed above. For example, the lens elements 510, 512 can include linear polarizers, the lens element 510, 512 also include light absorbing dyes, photochromic films, or other transmission modifiers. In some embodiments, the lens elements 510, 512 can be prescription lenses, such as water white prescription lenses. The lens elements 510, 512 can be formed in a variety of shapes and sizes. In some instances, the front and/or back surfaces of the lens elements 510, 512 can be curved, and can conform to the shape of a sphere, or a toroid, or other suitably curved shape. The front and/or back surface of the lens elements 510, 512 can also be flat.

The 3D eyewear 500 can include a right auxiliary lens element 514 and a left auxiliary lens element 516, which can be configured to removably attach to the front surfaces of the right and left lens elements 510, 512 respectively. If the front surfaces of the lens elements 510, 512 are curved, the auxiliary lens elements 514, 516 can be formed having similar curvature so that the back surfaces of the auxiliary lens elements 514, 516 can interface substantially flush against the respective front surfaces of the lens elements 510, 512. In some embodiments, the auxiliary lens elements 514, 516 can be flexible to facilitate placement on the lens elements 510, 512. In other embodiments, the auxiliary lens elements 514, 516 can be rigid or semi-rigid.

The auxiliary lens elements 514, 516 can be configured to provide 3D viewing capabilities to the eyeglasses 502. In embodiments where the lens elements 510, 512 include linear polarizers, the auxiliary lens elements 514, 516 can each include a quarter-wave plate. When the auxiliary lens elements 514, 516 are attached to the lens elements 510, 512 in the desired orientation, the right auxiliary lens element 514 and the right lens element 510 can combine to function as a first circular polarizer configured to substantially block light that is circularly polarized in a first direction (e.g., right-handed circularly polarized light), and the left auxiliary lens element 516 and the left lens element 512 can combine to function as a second circular polarizer configured to substantially block light that is circularly polarized in the opposite direction (e.g., left-handed circularly polarized light). The linear polarizers and quarter-wave plates can be positioned similar to, and can function in a manner similar to, that discussed in connection with FIGS. 2-5, except that the auxiliary lens elements 514, 516 are configured to attach directly to the lens elements 510, 512.

In some embodiments, the auxiliary lens elements 514, 516 can have shapes that are substantially the same as the shapes of the respective lens elements 510, 512, and the shapes can be selected such that the right auxiliary lens element 514 can only be attached to the right lens element 510 in the desired orientation, and such that the left auxiliary lens element 516 can only be attached to the left lens element 512 in the desired orientation. Thus, the shapes of the lens elements 510, 512, and the auxiliary lens elements 514, 516 can be configured to prevent a user from attaching the auxiliary lens elements 514, 516 to the incorrect lens elements 510, 512 or in an improper orientation. Thus, in some embodiments, the auxiliary lens elements 514, 516 can be configured to be used with specific lens shapes.

In some embodiments, auxiliary lens elements 518, 520 that are compatible with many different lens shapes can be used. For example, the auxiliary lens elements 518, 520 can be made of a size and shape that can fit onto a variety of lens element shapes and sizes. In the embodiment shown in FIG. 8, auxiliary lens elements 518, 520 having circular profiles are shown, although a variety of other profile shapes can be used, such as oval, squared, rectangular, or any other suitable shape. In some embodiments, the auxiliary lens elements 518, 520 can be rectangular in profile shape and can have an aspect ratio that is substantially the same as the aspect ratio used to present the images for stereoscopic viewing (e.g., 16:9 or 4:3). In many instances, these auxiliary lens elements 518, 520 may leave a substantial outer portion of the lens elements 510, 512 uncovered, but because the viewing of stereoscopic images is predominantly along the strait ahead viewing axis, these auxiliary lens elements 518, 520 can impart satisfactory 3D viewing capabilities without covering the entire lens elements 510, 512. Although FIG. 8 illustrates four auxiliary lens elements, 514, 516, 518, 520, only one auxiliary lens element should be used on each lens element 510, 512. Thus, a user could apply the auxiliary lens elements 514, 516, or the user could instead apply the lens elements 518, 520.

In some embodiments, the auxiliary lens elements 518, 520 can include markings 522, 524 to indicate the desired orientation of the auxiliary lens elements 518, 520. The frame 504 can include corresponding markings 526, 528 configured to align with the markings 522, 524 when the auxiliary lens elements 518, 520 are properly oriented. The markings 526, 528 can be colored dots, or raised or indented portions of the frame, or any other feature that can be used to align the corresponding markings 522, 524 on the auxiliary lens elements 518, 520. In some embodiments, the markings 526, 528 can be located on the back side of the frame, rather than on the front side of the frame as shown in FIG. 8. Thus, the markings 526, 528 can be hidden from view when the user wears the eyeglasses 502 so that the markings 526, 528 do not detract from the style of the eyeglasses 502. If the markings 526, 528 are located on the back of the frame 504, the user can align the auxiliary lens elements 518, 520 while looking through the lens elements 510, 512 so that all of the markings 522, 524, 526, 528 can be viewed at the same time.

In some embodiments, the frame does not include markings 526, 528, and auxiliary lens elements 514, 516 which can be properly aligned without the use of alignment markings can be used. Alternatively, the markings 522, 524 on the auxiliary lens elements 518, 520 can be positioned such that the auxiliary lens elements 518, 520 are properly aligned when the markings 522, 524 are positioned at an easily recognizable position (e.g., at the very top of the auxiliary lens element, or pointing straight up). Thus, by instructing the user to rotate the auxiliary lens elements 518, 520 until the markings 522, 524 are at the easily recognizable position, the auxiliary lens elements 518, 520 can be properly oriented without the need for markings 526, 528 on the frame 504. In some embodiments, the auxiliary lens elements 518, 520 can be more precisely aligned when the frame includes markings 526, 528.

In some embodiments, the marking 522 on the right auxiliary lens element 518 can be a letter R, and the marking 524 on the left auxiliary lens element 520 can be a letter L, to facilitate distinguishing right from left auxiliary lens elements. The markings 522, 524 can be arrows or other shapes, and can be color coordinated to differentiate right from left auxiliary lenses. Many variations are possible.

Turning now to FIG. 8A, the eyeglasses 502 of FIG. 8 are shown having auxiliary lens elements 518′, 520′ attached to the respective lens elements 510, 512 thereof. The auxiliary lens elements 518′, 520′ can have any of a variety of visual indicium of rotational orientation to enable proper alignment with respect to the underlying lens. In the illustrated embodiment, tabs 522′, 524′ lines or other visual markings are provided on the auxiliary lens, configured to point in a predetermined direction such as substantially directly downward when the auxiliary lens elements 518′, 520′ are properly rotationally oriented on the lens elements 510, 512.

In some embodiments, the front surface of each of the lens elements 510, 512 can have an exposed surface area, when mounted in the frame 504, of at least about 0.75 square inches and/or no more than about 7.0 square inches, and often of at least about 1.0 square inch and/or no more than about 4.0 square inches. The auxiliary lens elements 518′, 520′ can have a smaller surface area, such as at least about 0.25 square inches and/or no more than about 2.0 square inches, and often at least about 0.75 square inches and/or no more than about 1.5 square inches. In some embodiments, an auxiliary lens element 518′, 520′ can have a surface area of no more than about 85%, no more than about 70%, or no more than about 60% of the surface area of the respective lens element 510, 512 to which it is applied. Thus, in the mounted configuration, a first zone which extends from the wearer's straight ahead normal line of sight includes both the lens element 510, 512 and the auxiliary lens element 518′, 520′. A second zone surrounds the first zone and includes the underlying lens element 510, 512, but not the auxiliary lens element 518′, 520′. The width of the second zone can vary depending on the profiles of the lens elements 510, 512 and the profiles of the auxiliary lens elements 518′, 520′. In some embodiments the second zone can be at least about 0.25 inches, at least about 0.35 inches, or at least about 0.45 inches wide. In some embodiments, the auxiliary lens elements 518′, 520′ can have a profile shaped similar to, but smaller than, the lens elements 510, 512 such that the width of the second zone can be substantially equidistant across substantially its entire circumference.

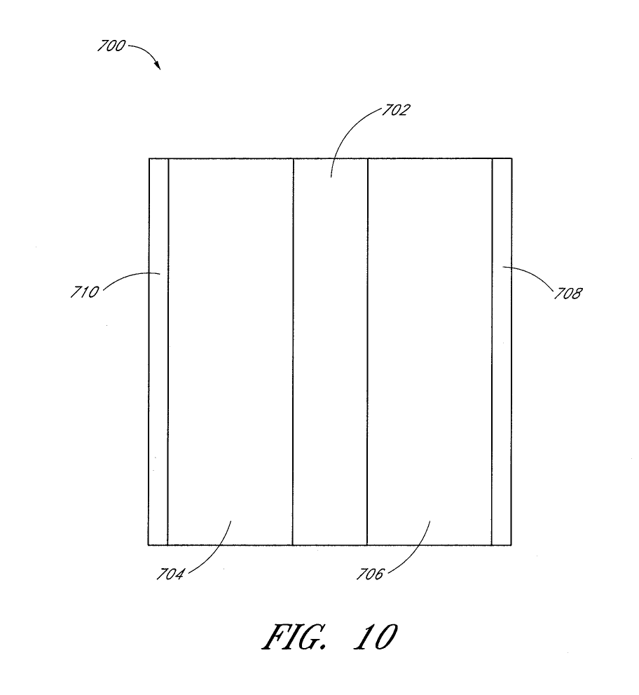

Turning now to FIG. 9, an auxiliary lens element 600 is shown that can be used as either the right auxiliary lens element 518 or the left auxiliary lens element 520 depending on its orientation. Thus, the need to manufacture separate right and left auxiliary lenses can be eliminated in some embodiments, thereby reducing the cost. Also, because the user need not distinguish between right and left auxiliary lenses, the distribution and use of the auxiliary lens elements can be simplified. The auxiliary lens element 600 can include a right marking 602 which can be used to orient the auxiliary lens element 600 when it is attached to the right lens element 510, and a left marking 604 which can be used to orient the auxiliary lens element 600 when it is attached to the left lens element 512. The right marking 602 can be, for example, a letter R, and the left marking 604 can be, for example, a letter L. The auxiliary lens element 600 can include a quarter-wave plate 606 that has a fast axis 608 and a slow axis 610. As can be seen by comparing FIG. 9 to FIG. 3, when the auxiliary lens element 600 is oriented with the right marking 602 at the top, the quarter-wave plate 606 can be oriented similar to the first quarter wave-plate 262 of the right auxiliary lens element 254, and can form part of a circular polarizer configured to filter out light that is circularly polarized in a first direction, as discussed in detail above. Similarly, when the auxiliary lens element 600 is oriented with the left marking 604 at the top, the quarter-wave plate 606 can be oriented similar to the second quarter-wave plate 268 of the left auxiliary lens element 256, and can form part of a circular polarizer configured to filter out light that is circularly polarized in the opposite direction, as discussed in detail above.

Returning now to FIG. 8, in some embodiments, the lens elements 510, 512 do not include linear polarizers. Thus, in some embodiments, the auxiliary lens elements 514, 516 or 518, 520 can include both the quarter-wave plate and the linear polarizer, so that the circular polarizer is entire contained within the auxiliary lens element, and so that the corresponding lens element 510 or 512 does not contribute to the 3D viewing functionality of the eyewear. This configuration can be desirable for users that wear eyeglasses with unpolarized prescription lenses (e.g., white water prescription lenses). Because the circular polarizers can be entirely contained within the auxiliary lens elements 514, 516 or 518, 520, and because the polarization of a circular polarizer does not change when it is rotated, in some embodiments, the auxiliary lens elements 514, 516 or 518, 520 can function properly regardless of their rotational orientation. Thus, in some embodiments, the lens auxiliary lens elements 518, 520 can contain no markings 522, 524 for alignment. However, in some embodiments, the auxiliary lens elements 514, 516 or 518, 520 can still include markings 522, 524 or shapes that prevent the user from attaching an auxiliary lens element to the incorrect lens element 510, 512.

Many variations are possible. For example, in embodiments wherein a lens element does not include a linear polarizer, the circular polarizer can be formed by applying a first auxiliary lens element having a quarter-wave plate to the front surface of the lens element, and applying a second auxiliary lens element having a linear polarizer to the back surface of the lens element.

Although many embodiments are described in connection with circular polarizers and circularly polarized light, it will be understood that other stereoscopic viewing techniques can be used. For example, in some embodiments, the auxiliary lens elements 514, 516 or 518, 520 can include linear polarizers. The right auxiliary lens element 514 or 518 can have a transmission axis configured to align in a first direction when oriented in the desired orientation (e.g., as indicated by markings 522, 526). The left auxiliary lens element 516 or 520 can have a transmission axis configured to align in a second direction, substantially orthogonal to the first direction, when oriented in the desired orientation (e.g., as indicated by markings 524, 528). Thus, the right auxiliary lens element 514 or 518 can filter out left-eye images that are polarized in the second direction, and the left auxiliary lens element 516, 520 can filter out right-eye images that are polarized in the first direction. Other techniques can also be used. For example, the auxiliary lens elements 514, 516 or 518, 520 can include different colored dyes that can filter out respective right-eye and left-eye images as is known in the art.

In some embodiments, the right lens element 510 and left lens element 512 can be integrally formed as a single, unitary lens element. In embodiments having a unitary lens, the right lens element 510 refers to the portion of the unitary lens element associated with the wearer's right eye, and the left lens element 512 refers to the portion of the unitary lens element associated with the wearer's left eye. Similarly, in some embodiments, the auxiliary lens elements 514, 516 or 518, 520 can be integrally formed as a single, unitary auxiliary lens element. In embodiments having a unitary auxiliary lens, the right auxiliary lens element 514 or 518 refers to the portion of the unitary auxiliary lens element associated with the wearer's right eye, and the left auxiliary lens element 516 or 520 refers to the portion of the unitary auxiliary lens element associated with the wearer's left eye.

The auxiliary lens elements 514, 516 or 518, 520 can be reusable, or they can be single-use, disposable units. The auxiliary lens elements 514, 516 or 518, 520 can be substantially rigid, semi-rigid, or flexible. The auxiliary lens elements 514, 516 or 518, 520 can be formed from various different materials and using various different methods.

FIG. 10 schematically illustrates a cross-sectional view of an example embodiment of a lens 700 for use as an auxiliary lens element configured to be removably attached to the front surface of a lens element. The lens 700 can include a quarter-wave plate 702 encased between layers 704, 706, which can be, for example, plastic material. The lens 700 can include a film or coating 708 applied to the back surface to facilitate the coupling of the back surface of the lens 700 to the front surface of the corresponding lens element. In some embodiments, a small amount of liquid (e.g., index matching liquid, or water) can be place between the back surface of the lens 700 and the front surface of the lens element to facilitate the coupling of the two surfaces. Thus, in some embodiments, the film or coating 708 can be omitted. In some embodiments, an optional antireflective coating can be applied to the front surface of the lens 700.

The quarter-wave plate 702 can be flexible and the surrounding layers 704, 706 can be made of a readily flexible plastic material (e.g., a polymeric plastic). In some embodiments, the flexibility of lens 700 can allow the lens 700 to be attached to the front surfaces of lens elements having a curvature that is similar to, but differs slightly from, the curvature of the lens 700. In some embodiments, the lens 700 can be semi-rigid or substantially rigid. For example, the lens 700 can be constructed similar to the lens 400 of FIG. 7.

In some embodiments, the surrounding layers 704, 706 can be injection molded around the quarter-wave plate 702. In some instances, the quarter-wave plate 702 can be encased between protective layers (not shown in FIG. 10) which can insulate the quarter-wave plate 702 during the injection molding. Various other manufacturing methods known in the art or yet to be devised can be used to form the lens 700. For example, in some embodiments, the plastic layer 706 can be formed to have the desired shape and curvature (e.g., by injection molding, spin casting, or lathing), after which the quarter-wave plate 702 can be added to the front surface of the layer 706 (e.g., by an adhesive, or by deposition of a birefringent material directly onto the front surface of the layer 706). In some embodiments, the layer 704 can be added to protect the quarter-wave plate 702.

Although the present invention has been described in terms of certain embodiments, other embodiments will become apparent to those of ordinary skill in the art in view of the disclosure herein. Several of the embodiments discussed herein can be modified to include different materials and dimensions than specifically described herein. For example, some embodiments may use 3D films, lamination techniques, or other features described in U.S. patent application Ser. No. 13/011,713 (Attorney Docket No. OAKLY1.329A), filed Jan. 21, 2011, and titled “LENSES FOR 3D EYEWEAR” the entire disclosure of which is hereby incorporated herein by reference and made a part of this specification for all that it discloses. The scope of the present invention is not intended to be limited by the recitation of the embodiments described herein, but is intended to be defined solely by reference to the appended claims.

What is claimed is:

1. Eyewear having three-dimensional viewing functionality, the eyewear comprising:
a main frame configured to be worn on the face of a wearer;
a right lens element supported by the main frame;
a left lens element supported by the main frame;
an attachment frame having a fastener configured to removably attach the attachment frame to the main frame;
a right auxiliary lens element supported by the attachment frame and positioned over the right lens element, wherein the right auxiliary lens element and right lens element cooperate to filter out light polarized in a first direction; and
a left auxiliary lens element supported by the attachment frame and positioned over the left lens element, wherein the left auxiliary lens and the left lens element cooperate to filter out light polarized in a second direction, wherein the second direction is different than the first direction.

2. The eyewear of claim 1, wherein the right lens element comprises a first linear polarizer, and wherein the left lens element comprises a second linear polarizer.

3. The eyewear of claim 2, wherein the first linear polarizer has a transmission axis and the second linear polarizer has a transmission axis, and wherein the transmission axis of the second linear polarizer is offset from the transmission axis of the first linear polarizer by an angle of deviation of less than about 15°.

4. The eyewear of claim 3, wherein the angle of deviation between the transmission axis of the second linear polarizer and the transmission axis of the first linear polarizer is less than about 5°.

5. The eyewear of claim 4, wherein the transmission axis of the second linear polarizer is substantially parallel to the transmission axis of the first linear polarizer.

6. The eyewear of claim 2, wherein the right lens element is integrally formed with the left lens element forming a unitary lens element, and wherein the first linear polarizer is integrally formed with the second linear polarizer.

7. The eyewear of claim 2, wherein the right auxiliary lens element comprises a first quarter-wave plate, and wherein the left auxiliary lens element comprises a second quarter-wave plate.

8. The eyewear of claim 7, wherein the first quarter-wave plate and the first linear polarizer cooperate to create a first circular polarizer configured to filter out light that is circularly polarized in the first direction, and the second quarter-wave plate and second linear polarizer cooperate to create a second circular polarizer configured to filter out light that is circularly polarized in the second direction, the second direction being substantially opposite the first direction.

9. The eyewear of claim 7, wherein the first linear polarizer is configured to be positioned closer to the wearer's eye than the first quarter-wave plate, and wherein the second linear polarizer is configured to be positioned closer to the wearer's eye than the second quarter-wave plate.

10. The eyewear of claim 7, wherein the first quarter-wave plate comprises a fast axis, wherein the second quarter-wave plate comprises a fast axis, and wherein the fast axis of the second quarter-wave plate is offset from the fast axis of the first quarter-wave plate by an angle of deviation between about 75° and about 105°.

11. The eyewear of claim 10, wherein the angle of deviation between the fast axis of the second quarter-wave plate and the fast axis of the first quarter-wave plate is between about 85° and about 95°.

12. The eyewear of claim 11, wherein the angle of deviation between the fast axis of the second quarter-wave plate and the fast axis of the first quarter-wave plate is about 90°.

13. A method of adding three-dimensional viewing functionality to eyewear, the method comprising:
providing eyewear having a right lens element and a left lens element; and
attaching an attachment to the eyewear, wherein the attachment comprises a right auxiliary lens element and a left auxiliary lens element, such that the right auxiliary lens element is positioned over the right lens element and the left auxiliary lens element is positioned over the left lens element, wherein the right auxiliary lens element and the right lens element cooperate to filter out light polarized in a first direction, and wherein the left auxiliary lens element and the left lens element cooperate to filter out light polarized in a second direction, the second direction being different than the first direction.

14. An eyewear attachment for adding three-dimensional viewing functionality to polarized eyewear, the attachment comprising:
a right auxiliary lens element comprising a first quarter-wave plate, wherein the right auxiliary lens element does not comprise a linear polarizer;
a left auxiliary lens element comprising a second quarter-wave plate, wherein the left auxiliary lens element does not comprise a linear polarizer;
an attachment frame supporting the right auxiliary lens element and the left auxiliary lens element; and
a fastener configured to removably attach the eyewear attachment to the eyewear.

15. The eyewear attachment of claim 14, wherein the first quarter-wave plate comprises a fast axis, wherein the second quarter-wave plate comprises a fast axis, and wherein the fast axis of the second quarter-wave plate is offset from the fast axis of the first quarter-wave plate by an angle of deviation between about 75° and about 105°.

16. The eyewear attachment of claim 15, wherein the angle of deviation between the fast axis of the second quarter-wave plate and the fast axis of the first quarter-wave plate is between about 85° and about 95°.

17. The eyewear attachment of claim 16, wherein the angle of deviation between the fast axis of the second quarter-wave plate and the fast axis of the first quarter-wave plate is about 90°.

18. The eyewear attachment of claim 14, wherein the fastener comprises one or more clips.

19. The eyewear attachment of claim 14, wherein the fastener is configured to removably attach the eyewear attachment to a main frame of the eyewear.

20. The eyewear attachment of claim 14, further comprising eyewear configured to removably receive the fastener, the eyewear comprising:
a main frame configured to be worn on the face of a wearer;
a right lens element supported by the main frame, the right lens element comprising a first linear polarizer; and
a left lens element supported by the main frame, the left lens element comprising a second linear polarizer;
wherein the first quarter-wave plate and the first linear polarizer cooperate to create a first circular polarizer configured to filter out light that is circularly polarized in the first direction, and the second quarter-wave plate and second linear polarizer cooperate to create a second circular polarizer configured to filter out light that is circularly polarized in the second direction, the second direction being substantially opposite the first direction.

21. The eyewear of claim 20, wherein the first linear polarizer has a transmission axis and the second linear polarizer has a transmission axis, and wherein the transmission axis of the second linear polarizer is offset from the transmission axis of the first linear polarizer by an angle of deviation of less than about 15°.

22. The eyewear of claim 21, wherein the angle of deviation between the transmission axis of the second linear polarizer and the transmission axis of the first linear polarizer is less than about 5°.

23. The eyewear of claim 22, wherein the transmission axis of the second linear polarizer is substantially parallel to the transmission axis of the first linear polarizer.

24. Eyewear having three-dimensional viewing functionality, the eyewear comprising:
a frame configured to be worn on the face of a wearer;
a right lens element supported by the frame, the right lens element having a front surface and a back surface;
a left lens element supported by the frame, the left lens element having a front surface and a back surface;
a right auxiliary lens element configured to removably attached to the front surface of the right lens element to thereby substantially block light polarized in a first direction from passing through the right lens element; and
a left auxiliary lens element configured to removably attach to the front surface of the left auxiliary lens element to thereby substantially block light polarized in a second direction from passing through the left lens element, wherein the second direction is different than the first direction.

25. The eyewear of claim 24, wherein the right auxiliary lens element comprises a first quarter-wave plate, and wherein the left auxiliary lens element comprises a second quarter-wave plate.

26. The eyewear of claim 25, wherein the right lens element comprises a first linear polarizer, and wherein the left lens element comprises a second linear polarizer, the first quarter-wave plate and first linear polarizer cooperating to form a first circular polarizer configured to substantially block light that is circularly polarized in the first direction, and the second quarter-wave plate and the second linear polarizer cooperating to form a second circular polarizer configured to substantially block light that is circularly polarized in a second direction, the second direction being substantially opposite the first direction.

27. The eyewear of claim 25, wherein the right auxiliary lens element comprises a first linear polarizer, and wherein the left auxiliary lens element comprises a second linear polarizer, the first quarter-wave plate and first linear polarizer cooperating to form a first circular polarizer configured to substantially block light that is circularly polarized in the first direction, and the second quarter-wave plate and the second linear polarizer cooperating to form a second circular polarizer configured to substantially block light that is circularly polarized in a second direction, the second direction being substantially opposite the first direction.

28. The eyewear of claim 24, wherein the right lens element and the right auxiliary lens element are shaped so that the right auxiliary lens element can only be attached to the right lens element in a desired orientation, and wherein the left lens element and the left auxiliary lens element are shaped so that the left auxiliary lens element can only be attached to the left lens element in a desired orientation.

29. The eyewear of claim 24, wherein the right auxiliary lens element comprises a marking configured to indicate a desired orientation of the right auxiliary lens element, and wherein the left auxiliary lens element comprises a marking configured to indicate a desired orientation of the left auxiliary lens element.

30. The eyewear of claim 29, wherein the frame comprises a right frame marking configured to align with the marking on the right auxiliary lens element when the right auxiliary lens element is oriented in the desired orientation, and wherein the frame comprises a left frame marking configured to align with the marking on the left auxiliary lens element when the left auxiliary lens element is oriented in the desired orientation.

31. The eyewear of claim 24, wherein the right and left auxiliary lens elements are flexible.

32. The eyewear of claim 24, wherein the right auxiliary lens element has a curvature that is substantially the same as the curvature of the front surface of the right lens element, and wherein the left auxiliary lens element has a curvature that is substantially the same as the curvature of the front surface of the left lens element.

33. The eyewear of claim 32, wherein the curvatures of the front surfaces of the right and left lens elements are substantially spherical in shape, and wherein the curvatures of the right and left auxiliary lens elements are substantially spherical in shape.

34. The eyewear of claim 24, wherein at least one of the right and left lens elements is a prescription lens element.

35. The eyewear of claim 24, wherein the right lens element is integrally formed with the left lens element forming a unitary lens element.

36. The eyewear of claim 24, wherein the right auxiliary lens element is integrally formed with the left auxiliary lens element forming a unitary auxiliary lens element.

37. A method of adding three-dimensional viewing functionality to eyewear, the method comprising:
providing eyewear having a right lens element and a left lens element, the right lens element having a front surface and a back surface, and the left lens element having a front surface and a back surface;
attaching a right auxiliary lens element to the front surface of the right lens element to thereby substantially block light polarized in a first direction from passing through the right lens element; and
attaching a left auxiliary lens element to the front surface of the left lens element to thereby substantially block light polarized in a first direction from passing through the right lens element, wherein the first direction is different than the second direction.

38. An auxiliary lens element for adding three-dimensional viewing functionality to eyewear, the auxiliary lens element comprising:
a front surface;
a back surface configured to removably attach to a front surface of a lens element of the eyewear; and
a quarter-wave plate, having a fast axis.

39. The auxiliary lens element of claim 38, further comprising a linear polarizer having a transmission axis, wherein the fast axis of the quarter-wave plate is offset from the transmission axis of the linear polarizer by an angle of deviation of between about 40° and 50°.

40. The auxiliary lens element of claim 39, wherein the angle of deviation between the fast axis of the quarter-wave and the transmission axis of the linear polarizer is about 45°.

41. The auxiliary lens element of claim 38, further comprising eyewear configured to receive the auxiliary lens element, the eyewear comprising:
a frame configured to be worn on the face of a wearer; and
at least one lens element supported by the frame, the lens element having a front surface and a back surface, wherein the front surface of the lens element is configured to receive the back surface of the auxiliary lens element to removably secure the auxiliary lens element to the lens element.

42. The auxiliary lens element of claim 41, wherein the lens element comprises a linear polarizer.

43. The auxiliary lens element of claim 38, further comprising:
a right marking indicating the proper orientation of the auxiliary lens element on a right lens element; and
a left marking indicating the proper orientation of the auxiliary lens element on a left lens element.
